(19) United States
(12) Patent Application Publication
(10) Pub. No.: US 2014/0356485 A1
(43) Pub. Date: Dec. 4, 2014

(54) GRAPE SEED EXTRACT FOR BROWNING FOOD SURFACES

(71) Applicants: Sandrine Cavin, Epalinges (CH); Karlheinz Bortlik, Syens (CH); Martin Michel, Lausanne (CH)

(72) Inventors: Sandrine Cavin, Epalinges (CH); Karlheinz Bortlik, Syens (CH); Martin Michel, Lausanne (CH)

(21) Appl. No.: 14/344,763

(22) PCT Filed: Aug. 17, 2012
(86) PCT No.: PCT/EP2012/066115

§ 371 Date: Mar. 13, 2014

Related U.S. Application Data
(60) Provisional application No. 61/534,682, filed on Sep. 14, 2011.
(60) Provisional application No. 61/558,510, filed on Nov. 11, 2011.

(30) Foreign Application Priority Data
Sep. 13, 2011 (EP) 11181076.8
Nov. 11, 2011 (EP) 11188817.8

(51) Int. Cl. A23L 1/27; A23P 1/08

(52) U.S. Cl. CPC A23L 1/27; A23P 1/081
USPC 426/94; 426/93; 426/262; 426/241

(57) ABSTRACT

The present invention relates to a food product coated on a surface with an oil free extract from grape seeds. Embodiments of the invention further relate to a method for coloring a surface of said food product when heated, and a use of an oil free extract from grape seeds to color a surface of a food product when heated, for example in a microwave oven.

The present invention relates to a food product coated on its surface with an oil free extract from grape seeds. Embodiments of the invention further relate to a method for coloring a surface of said food product when heated, and a use of an oil free extract from grape seeds to color a surface of a food product when heated, for example in a microwave oven.

The usage of microwave ovens in homes has increased significantly in recent years and continues to increase. While microwave cooking of foods affords a significant time saving over conventional oven cooking, it suffers from the disadvantage that food products cooked by microwave energy lack the desired degree of surface browning, that particularly those have that have a crust, such as pies, pizzas, bread, dough's etc. have when cooked in a conventional oven.

The most common reaction responsible for surface browning during cooking of products having a dough crust is the well-known Maillard reaction (i.e. non-enzymatic browning). This reaction occurs between naturally occurring reducing sugars and compounds containing an amino group, e.g. amino acids, peptides and proteins, and results in the formation of colored melanoidins. The rate at which the Maillard reaction proceeds to form such colored pigments increases significantly with temperature and time. When foods containing a dough crust, such as for example a frozen pizza, a bread or a snack, are heated in a conventional oven, the crust is heated to considerably higher temperatures than the interior of the food product, with the high surface temperatures being sufficient to achieve the desired browning.

However, in microwave heating the heat energy is released internally within the food product so that the surface remains at a relatively even temperature with the interior. There is a lack of hot, dry air surrounding the food product during microwave cooking. In addition, the food is usually cooked for a much shorter time. Consequently, the high surface temperatures necessary to achieve browning are not reached within the time required to bake the food product. The surface of the product remains moist and pale: the desired development of a nice brown surface color does not appear. The end-product, although well cooked, is often perceived as under-cooked by the consumer.

A number of compositions have been proposed to create a desirable browned surface of a food product when heated by microwave energy. Such prior microwave browning compositions typically are based on the Maillard reaction to effect browning, and include one or more components which permit the reaction to take place at lower temperatures or which increase the reaction rate. Such compositions typically include carbohydrates such as for example dextrose, maltodextrin and acetaldehyde compounds which result from pyrolysis of some of the sugar compounds prior to constitution of the browning composition (see U.S. Pat. No. 5,756,140). However, none of these prior compositions have been entirely satisfactory due to flavor concerns, the limitation of achievable color variations on a food product, and costs. Further, the presence of acetaldehydes and potentially still other compounds from the pyrolysis process may be perceived as less natural by consumers.

EP0481249 proposes a method to use an amount of water soluble tea solids applied to a food surface to develop a browned surface on the crust of such a food when heated by microwave energy. The shortcoming of the proposed method is that food products treated with such soluble tea solids retain a distinct flavor and taste of black tea. For most product applications, this is clearly not desired. It is believed that this significant flavor impact is due to the fact that a relatively high concentration of tea solids is needed to be applied to the food surface in order to be effective for the development of a desired surface coloration. A further major inconvenience of the application is that the food surface remains moist and soft. Hence, this solution does not provide the consumer with the impression of a well-cooked product with a well-developed crust. Furthermore, such treated products may retain certain astringency as well as a certain level of caffeine which may not be desired by consumers, particularly by children.

Currently on the market and commercially used is “Liquid or powder Smoke” (Red Arrow Products Company LLC, Manitowoc, Wis., USA). “Liquid or Powder Smoke” overcomes the currently missing solution for fast browning of food surfaces in microwave applications. However, “Liquid Smoke” may not be well perceived by consumers. It contains aldehydes which have to be labeled on the packaging of the food products. Currently, the EFSA (European Food Safety Authority) is investigating the safety of “Liquid Smoke” as a food flavoring agent. Hence, there is a clear need in the art to replace these substances with natural, safe compositions which can effectively be used on food products for inducing coloration of food surfaces upon heating for example in a microwave oven. Further, these compositions should be odorless or at least not having a negative impact on the final flavor of such a treated food product.

The object of the present invention is to provide an improved solution for coloring surfaces of food products to be heated thereafter, for example in a microwave oven, and which overcomes at least some of the inconveniences described above.

The object of the present invention is achieved by the subject matter of the independent claims. The dependent claims further develop the idea of the present invention.

Accordingly, the present invention pertains to a food product coated, partially or completely, on its surface with a coating comprising an oil free extract from grape seeds.

In a second aspect, the invention relates to a method for coloring a surface of a food product when heated, comprising the steps of coating said surface with an oil free extract from grape seeds, and heating said product thereafter in order to develop a color of the surface.

A further aspect of the invention is the use of an oil free extract from grape seeds to coat a surface of a food product in order to develop a colored surface of said product when heated.

The inventors surprisingly found that appealing brownish colors develop on the surface of food products during heating, particularly during heating in a microwave oven, if such surface has been coated with a polyphenol-rich oil free extract from grape seeds prior to the heating. When combining such surface coating further with a chemical base such as a sodium bicarbonate or sodium hydroxide solution, the appearance of the brownish color can be even more intensified and/or give raise to interesting new color variations within the brown range of the color spectrum.

This finding can now advantageously be applied to coat un- or prebaked food products with a transparent and nearly colorless surface coating, which upon baking in for example a microwave oven develop a brown color of the food crust. It is of great advantage that the use of an oil free extract from grape seeds is a natural solution and that there are no safety concerns to consumers. Furthermore, products coated with an oil free extract from grape seeds do not have or develop any negatively perceived flavors or odors either before or after a heat treatment. A further advantage is that concentrations of such grape seed extracts with or without the chemical base, which can be applied either separately or mixed with the extract, can be applied in appropriate concentrations to such food surfaces without leading to moist and soft surfaces.

Furthermore, the inventors have found that the invention for coloration of a food product surface in a microwave oven works particularly well, if the food product before the heating in the oven is in a frozen state and/or if the oil free grape seed extract is applied first and separately from the chemical base onto said surface. Best results, however, are achieved by applying the oil free extract from grape seeds first in a first coating onto the surface of the frozen food product and thereafter in a second step applying the chemical base to said coating of the still frozen food product in a second separate layer. It has been found by the inventors that the frozen state of the food product as well as the separate application of the oil free grape seed extract from the chemical base help to further slow down the color reaction at the food surface before the heating step e.g. during long term storage of the such treated food product. It is thereby possible to make food products with a quasi invisible colorless coating and which can be stored for an extended period of time with maintaining this coating invisible, which when heated in a microwave oven develop very nice and appetizing brown surface colors.

### BRIEF DESCRIPTION OF THE DRAWINGS

FIG. 1: Browning reaction of oil free grape seed extract from different suppliers coated on a dough surface before and after heating in a microwave oven.

FIG. 2: Browning reaction of oil free grape seed extract coated on a dough surface applied in different surface concentrations on dough with and without the addition of baking soda.

FIG. 3: Development of luminosity and color variation of the coating of a dough surface upon addition of baking soda.

FIG. 4: Browning reaction of oil free grape seed extract coated on a dough surface applied with and without Mn ions before and after heating in a microwave oven.

FIG. 5: Browning reaction of oil free grape seed extract coated on a dough surface applied with and without Fe ions before and after heating in a microwave oven.

### DETAILED DESCRIPTION OF THE INVENTION

The present invention pertains to a food product coated with a colorless coating on a surface with an oil free extract from grape seeds.

Thereby, a “colorless coating” is understood as a coating on a food product surface which is transparent and without color. Hence, the colorless coating does not provide an own, proper color to the food product surface. A consumer looking at a food product with such a defined surface coating will not perceive a color coming from the coating per se.

The product of the invention can be coated on just one or several surfaces, if available. Preferably, the surface selected for the coating is the exterior face or part of the exterior face of the product which is visible upon presentation of the food product to a consumer.

An “oil free extract from grape seeds” can be obtained by crushing grape seeds with water and discarding the non-soluble and oil containing fractions. “Oil free” means that the extract does not contain oil from the seeds. Alternatively, oil free grape seed extract is commercially available and can be purchased from Indena France SAS, Paris, France, or Naturex, Avignon, France. Preferably, an extract of grape seeds is of natural origin. It can be applied to a food surface for example as a solution of ca. 0.1 to 5 wt % of extract in water, further optionally comprising a binder or thickener as for example pectin, xanthan, agar, dextrin, a gum adhesive agent or another food-grade hydrocolloid, in order to facilitate the technical applicability of the product to a food surface.

The solution with the oil free grape seed extract is applied in such a way to the surface of a product that the amount of the extract from grape seeds on said surface is in the range from 0.01 to 1.0 mg/cm², preferably from 0.03 to 0.5 mg/cm², more preferably from 0.06 to 0.2 mg/cm². These concentrations of the extract on the surface allow on one hand to provide a practically in-color food product surface coating before the baking or heating step, and on the other hand allow the food surface to develop a sufficiently satisfying color appearance after the heating in for example a microwave oven.

The food product of the present invention is further coated with a solution comprising a chemical base applied to said surface together with or separately of the oil free extract from grape seeds. Thereby, the chemical base can be directly mixed into the solution comprising the extract of grape seeds and the pH of the originally acidic extract can be adjusted to a pH value between pH 7 and pH 8.5, for example. Alternatively, the chemical base can be applied separately to the surface either before or after applying the oil free grape seed extract solution, for example by spraying it directly onto said surface. As chemical base for example a solution of sodium bicarbonate such as conventional baking soda or sodium hydroxide can be applied.

The use of a chemical base together with the oil free grape seed extract has the advantage of accelerating the development of the desired color reaction. Thereby, the color appearance develops faster and more intense upon heating of the product surface. Further, using a developer such as a chemical base allows reducing the amount of oil free grape seed extract necessary for reaching the desired food coloring after the heating step. Hence, the objective to provide an as colorless food surface before heating and a well colored surface after heating can be achieved in this way.

In a preferred embodiment, the surface coating of the food product of the invention comprises less than 10⁻⁵ mMol/cm², preferably less than 10⁻⁶ mMol/cm², even more preferably less than 10⁻⁷ mMol/cm² ions of a transition metal, particularly of manganese and/or zinc ions. The advantage of having no or only a very limited amount of metal ions in the food product surface coating is to prevent possible off-tastes of the food product as well as a loss of quality due to the presence of such metal ions. Metal ions are known to have some off-taste and to enhance oxidation of certain compounds found in foods such as for example lipids. Hence, the presence of metal ions may lead to a faster loss of the food product quality as well as to negative organoleptic impacts due to undesired oxidation reactions.

In an alternative preferred embodiment, the food product of the invention is further coated with an ion of a transition metal, wherein the amount of the ion of a transition metal on the surface of said product is in the range from 0.00001-1.0 mg/cm², preferably from 0.0001-0.1 mg/cm², more preferably from 0.001-0.05 mg/cm².

It has been observed that the presence of transition metal ions together with the oil free grape seed extract has a synergistic effect in further and faster developing the color reaction at a food surface. Hence, in selecting appropriate concentrations of transition metal ions in combination with the extract from grape seeds, the intensity and speed of the surface color development can be modified and optimized according to individual specific food applications and preferences.

The metal ions are of a transition metal, wherein the transition metal is selected from the group consisting of Fe, Mn, Co, Cr, Zn and Cu, or a combination thereof. Preferably, the transition metal is selected from the group consisting of Zn, Fe, Cu and Mn, or a combination thereof. Different metal ions react differently together with the extract, resulting in slightly but distinct different color appearances within the brownish range of the color spectrum. This again allows adapting not only color intensity but also the color per se for an individualized use of the invention according to the desired product application.

The food product of the invention is to be heated, and particularly so, the surface of said food product is to be heated. Typically, such heating can be achieved in a conventional oven or by any other means of heating a product or its surface such as for example by exposing the product to a heating lamp or infrared heater. Preferably, the product of the invention is heated in a microwave oven.

It is mainly for food products intended to be heated for a short time only and at relative lower surface temperatures that the invention provides a good solution to surface coloring. Hence, the invention is advantageously applied on food products intended for being heated in a microwave oven. For example, food products of the present invention are heated for at least 2 min at 250 Watts or higher, preferably for at least 4 min at said watts in a microwave oven. Alternatively, the food products are heated for 1 min 20 seconds or longer in the microwave oven at 600 Watts or higher.

The food product according to the invention pertains also to such products, wherein the surface is only partly coated with the oil free grape seed extract. Partly meaning a part of the entire product surface is only coated or treated with the extract. This allows to induce a colored surface of only certain parts of a food product, to apply for example certain designs or figures which only appear in color after heating or baking of the product. Further, pictures or short texts could be produced on food surfaces in the same way as well.

The food product according to the invention mainly pertains, but is not limited, to products selected from the group consisting of dough, bread, cookies, cereals, bakery products, pizzas, snacks, gratins, cooked pasta, lasagna, cheese and rice dishes, and meat.

Preferably, the food product is a frozen food product before being heated e.g. in a microwave oven. For example, the product is a frozen pizza; a frozen dough or bread product such as a Panini or Hot Pocket product; a frozen gratin, pasta, lasagna, cheese or rice dish.

The advantage of the invention for an application to a frozen food product is that the colorless coating is more stable and remains quasi invisible for a long period of storage, before developing the desired brown surface color upon the heating step, e.g. in a microwave oven.

A further aspect of the invention is a method for coloring a surface of a food product when heated, comprising the steps of i) coating the surface or a part thereof with a composition comprising an oil free extract from grape seeds, and ii) heating said product in order to develop a color of the surface.

The method of the invention further comprises the step of applying to said surface a solution comprising a chemical base before heating the product. The steps of the method can be of any order as long as they are all applied to the product surface before the heating step. To separate the individual steps as out-lined above has the advantage that it allows to separate the reactants to better control the coloring reaction.

Alternatively, the oil free grape seed extract composition and the chemical base can be applied together as a mixture in one solution comprising the grape seed extract and the chemical base onto the surface before the heating step. This solution allows simplifying the application of the invention to just one basic step of surface treatment and hence would reduce the costs of production.

In a still further embodiment, the composition comprising the oil free extract from grape seeds is encapsulated. A further embodiment is that the chemical base is encapsulated. A still further possibility is that both, the oil free grape seed extract as well as the chemical base are encapsulated, either separately or combined.

Encapsulation technology is well known in the art and could be applied here to either the grape seed extract and/or the chemical base. Condition is that the encapsulation releases its enclosed substances once heated above a critical temperature. Advantageously, the two components, the oil free grape seed extract and the chemical base, would not interact and react with each other while being encapsulated and present at the same time in the surface coating of a finished food product before the heating step. Upon heating, however, the components would be released from their encapsulation and could start to react and interact with each other. This would allow on one hand to improve color stability for increasing storage and distribution time of such coated food products, and on the other hand the perceived effect of surface coloring during the heating step could be significantly increased.

A further particular embodiment is the method of the invention, further comprising the step of applying to the surface of a food product a solution comprising an ion of a transition metal before heating the product in order to develop a color of the surface. The ion of the transition metal may be encapsulated or not.

Advantageously, the method of the invention is used for products which are intended to be heated in a microwave oven, for example in-home by a consumer. Upon heating in the microwave oven, the product does then develop a brownish color at the surface, typically for a well baked and appetizing product. Such brownish colors depend with the application, the food product type, the concentration and choice of the different reactants and can result in a variety of different color aspects.

Further advantageously, the method of the invention is for a food product, wherein the food product is in a frozen state before being heated in order to develop a color of the surface. It has been found by the inventors that the method of the invention works particularly well for frozen food products as any potential pre-colorization of the treated surface of such a frozen product, e.g. during a period of storage, is minimal before the heating step in comparison to for example a same treated surface of a non-frozen food product.

A further embodiment of the invention pertains to the use of an oil free extract from grape seeds to coat a surface of a food product in order to develop a colored surface of said product when heated, preferably when heated in a microwave oven. In order to achieve good results, the oil free extract from grape seeds comprises preferably from 60 to 90 wt % polyphenols.

Those skilled in the art will understand that they can freely combine all features of the present invention disclosed herein. In particular, features described for the product of the present invention may be combined with the method of the present invention and vice versa. Further, features described for different embodiments of the present invention may be combined.

Further advantages and features of the present invention are apparent from the figures and examples.

### Example 1

Several trials with oil free grape seed extracts from different suppliers were carried out. The grape seed extracts used are the following: grape seed (Naturex, France), Gravinol-T (Kikkomann, Japan), Vinoseed (Bioserae, France).

7.5 g of pectin (Pectin Classic CU 201, Herbstreith & Fox KG, Germany) was dissolved in 292.5 g of de-mineralized water, heated at 60° C. for 1 hour and the pH adjusted with NaOH to pH 4.5. A 0.5 wt % stock solution of each grape seed extract was prepared by adding 0.25 g of dried extract to 49.75 g of pectin solution. Subsequently, about 0.9 g of each stock solution was brushed onto the surface of dough buns covering about 60 cm² each, which corresponds to a concentration of extract of about 0.075 mg/cm² at the dough surface. Then, dough buns were cooked for 1 min 30 sec in a microwave oven (NN-255 Panasonic) at 750 Watts.

An additional set of experiments was carried out following the same procedure as described above. However, after application of the grape seed extract to the dough buns, about 0.45 g of a 1M solution of baking soda in water was sprayed onto the same dough surfaces before cooking in the microwave oven under the same conditions as above.

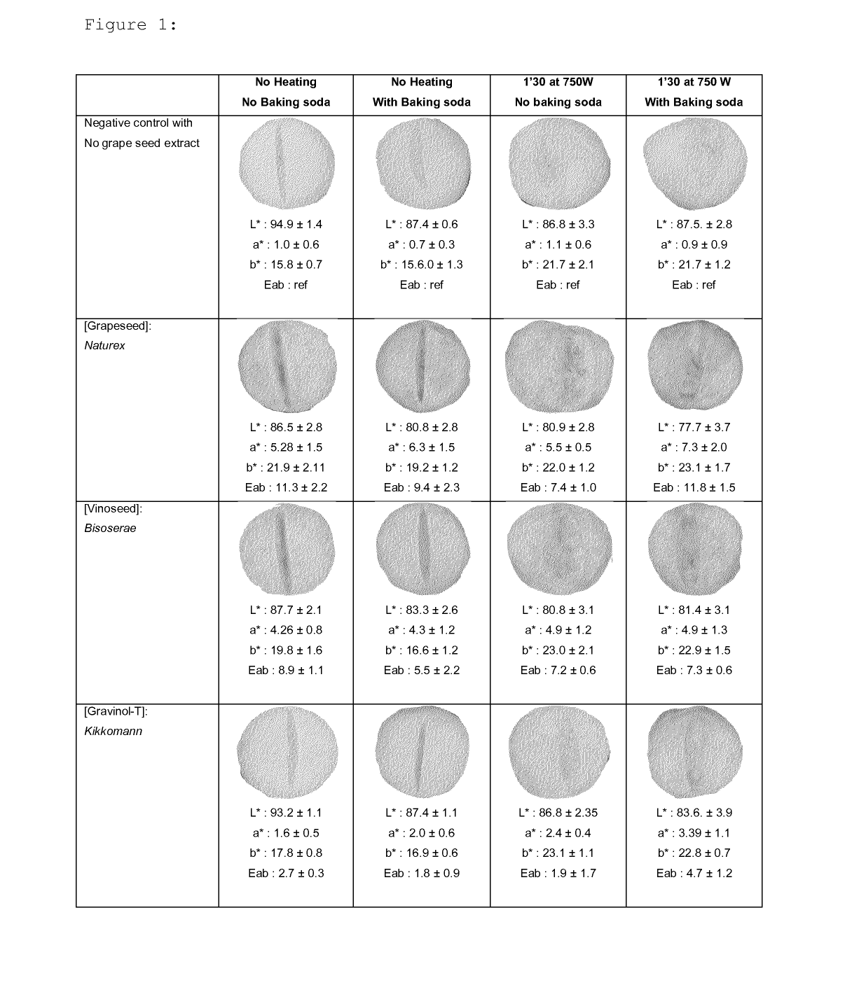

The result is shown in FIG. 1. As can be seen, there is a variation in colors, depending on the supplier and hence nature of the grape seed extract, as well as with the addition of baking soda.

### Example 2

12.5 g of pectin (Pectin Classic CU 201, Herbstreith & Fox KG, Germany) was dissolved in 487.5 g of de-mineralized water and heated at 60° C. for 1 hour. A 1 wt % stock solution was prepared by adding 0.5 g of grape seed extract (Naturex, France) into 49.5 g of pectin solution. Subsequently, several diluted solutions were prepared. About 0.9 g of each obtained solution was brushed onto dough bun surfaces to cover about 60 cm² each, to result in surface concentrations of grape seed extract of 0.015 mg/cm², 0.038 g/cm², 0.075 g/cm² and 0.15 mg/cm², respectively. The dough buns were cooked for 1 min 30 sec in a microwave oven (NN-255 Panasonic) at 750 Watts.

An additional set of experiments was carried out following the same procedure as described above. However, after application of the grape seed extract to the dough buns, about 0.45 g of a 1M solution of baking soda in water was sprayed onto the same dough surfaces before cooking in the microwave oven under the same conditions as above.

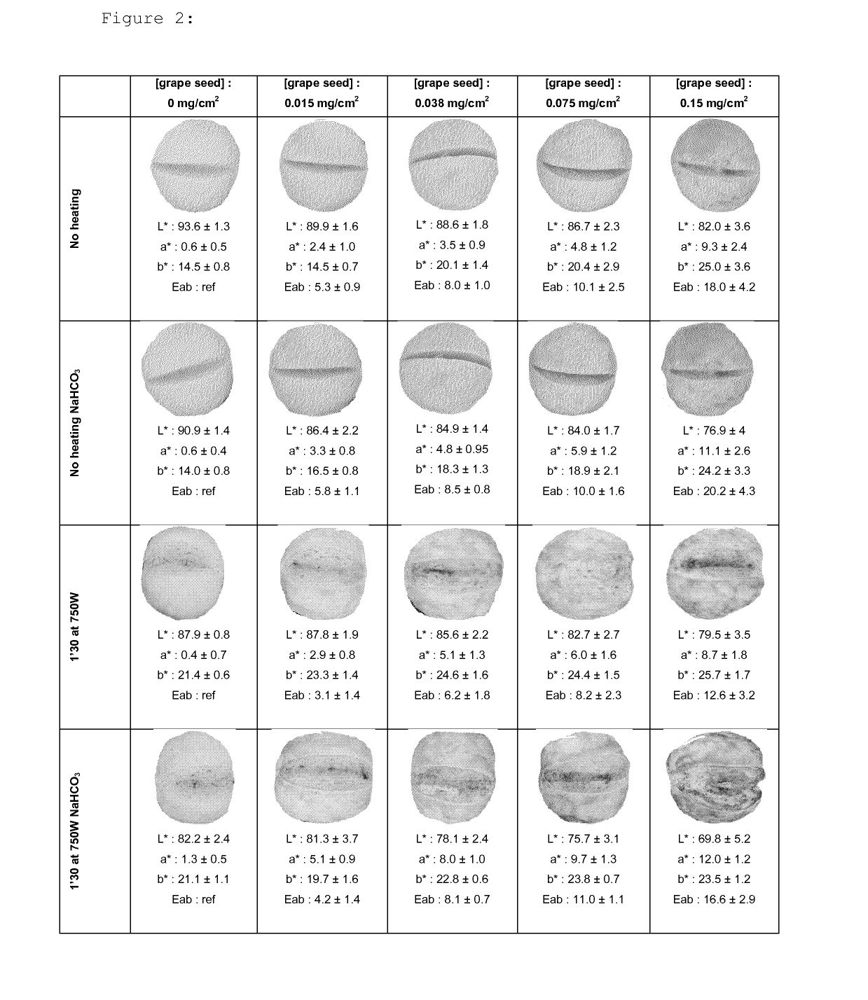

The results are shown in FIG. 2. As can be seen, the achieved coloring of the bread surface is more red and more intense when baking soda was added before the microwaving step.

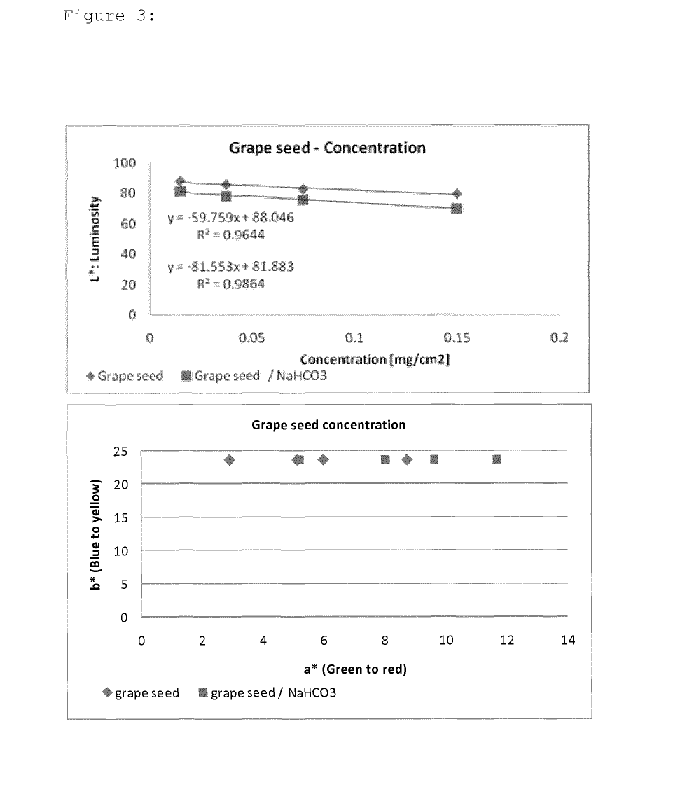

As shown in FIG. 3, the luminosity L* of the above generated dough surfaces decreases linearly and faster when baking soda was added. The yellow color remained stable (b*), while the red increased (a*) with concentration and faster when baking soda was added.

The detailed color analysis was carried out using the CIELab* notation. In the International Commission on Illumination (CIE), a color is represented by a point in a color space. The coordinates of such a point are: the luminosity L (L=0: black, L=100: white), a* the amount of red and green (a* positive: red, a* negative: green), and b* the amount of yellow and blue (b* positive: yellow, b* negative: blue). Visual color changes were evaluated by calculating the Euclidean distance between the two points which described the color before and after testing. The distance is represented by the equation:

DEab*=\sqrt{(L*₂−L*₁)²+(a*₂−a*₁)²+(b*₂−b*¹)²}

The Color analysis was registered using a computer controlled digital camera system (DigiEye, Verivide) with a D65 light source.

### Example 3

The grape seed extract solution from Naturex with a concentration of 1 wt % as of Example 1 was used. 0.4 g of this solution was sprayed onto the surface of a round dough pastry surface of 7.5 cm diameter (0.09 mg of extract/cm²). Subsequently and in the same way, 0.1 g of baking soda from a 1M solution was applied to the surface. Thereafter, the pastry dough was cooked for 2 min in a microwave oven (NN-255 Panasonic) at 250 Watts, and the resulting surface coloring was measured. The pastry dough was re-cooked again in one minute steps until a total of 6 minutes, and after each step the surface color was measured.

The results showed that the luminosity decreased during the increasing cooking time and the overal color of the dough surface is becoming more red-brown than yellow-brown.

### Example 4

The grape seed extract of Example 3 can be sprayed onto the surface of an uncooked lasagna (Lasagne Verdi al Formo from Fundus, Switzerland). Thereafter, the lasagna can be cooked in a microwave oven for 12 min between 650 and 750 Watts. A very nice brownish surface color will develop upon the microwave heating.

### Example 5

Several trials with oil free grape seed extracts from different suppliers were carried out. The grape seed extracts used are the following: grape seed (Naturex, France), Gravinol-T (Kikkomann, Japan), Vinoseed (Bioserae, France).

7.5 g of pectin (Pectin Classic CU 201, Herbstreith & Fox KG, Germany) was dissolved in 292.5 g of de-mineralized water, heated at 60° C. for 1 hour and the pH adjusted with NaOH to pH 4.5. A 0.5 wt % stock solution of each grape seed extract was prepared by adding 0.25 g of dried extract to 49.75 g of pectin solution. Salts containing transition metals, such as manganese and iron, were added thereafter as follows. Iron ions from ferrous gluconate hydrate were added to each grape seed extract solution to result in a 2 mM concentration of iron ions. Similar solutions were prepared with manganese ions coming from manganese chloride to result in a 10 mM concentration of manganese ions. Subsequently, about 0.9 g of each extract solution was brushed onto dough surfaces covering about 60 cm², which corresponds to a surface concentration of extract of about 0.075 mg/cm². The dough buns were then cooked for 1 min 30 sec in a microwave oven (NN-255 Panasonic) at 750 Watts.

An additional set of experiments was carried out following the same procedure as described above. However, after application of the grape seed extract to the dough buns, about 0.45 g of a 1M solution of baking soda in water was sprayed onto the same dough surfaces before cooking in the microwave oven under the same conditions as above.

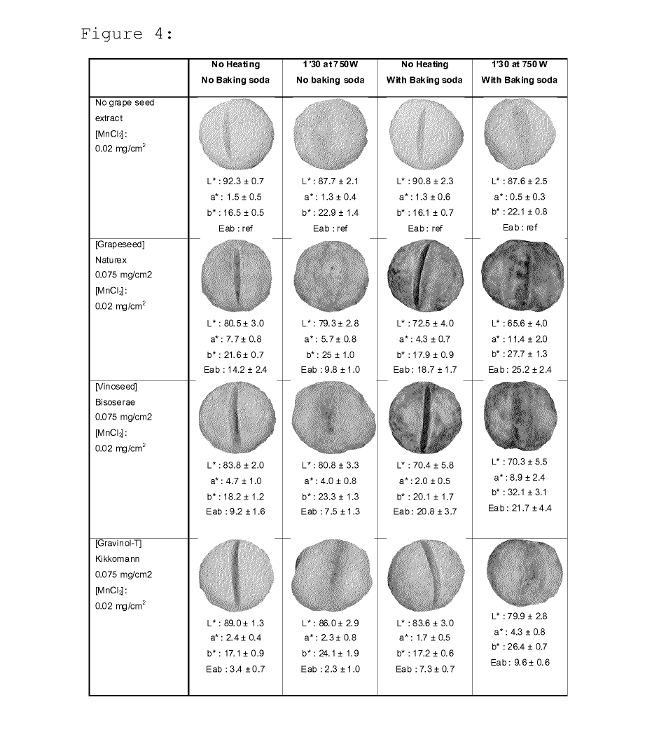

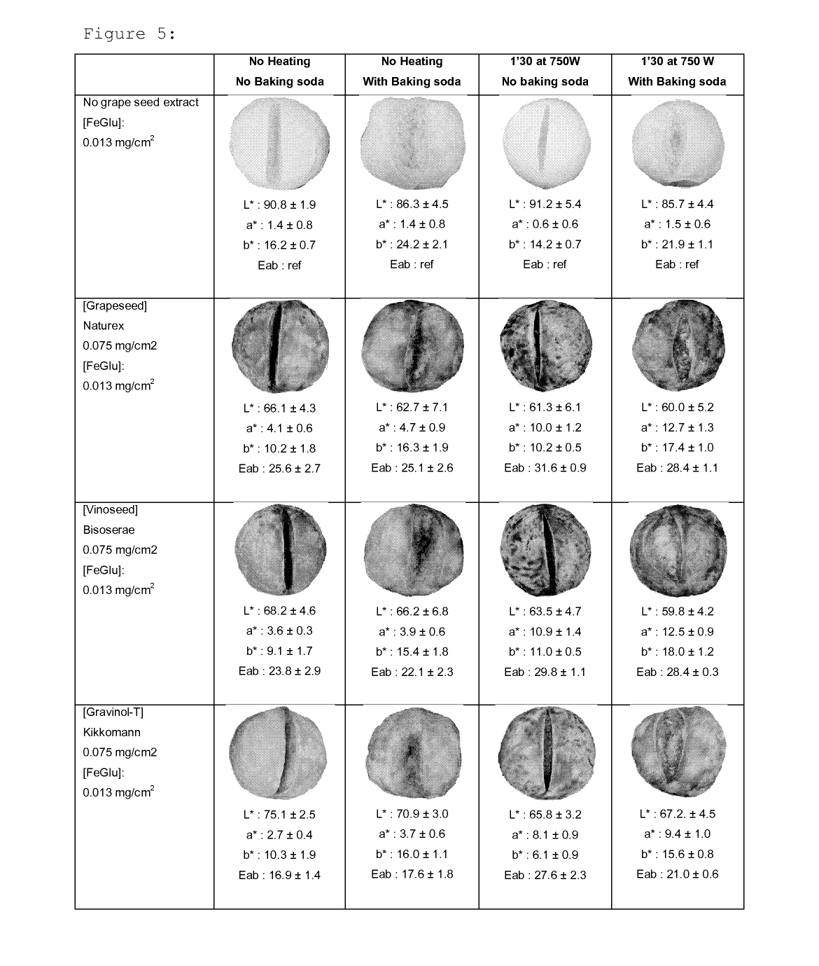

The results are shown in FIGS. 4 and 5. It was observed that the coloring is more pronounced when metal ions are present together with the grape seed extract on the bread surface. With the addition of baking soda, the resulting surface colors were even more intensive and became more brownish with manganese and more violet with iron.

1. A food product coated on a surface with a coating comprising an oil free extract from grape seeds.

2. The food product according to claim 1, wherein the coating is colorless.

3. The food product according to claim 1, wherein the amount of the oil free extract from grape seeds on the surface is from 0.01 to 1.0 mg/cm².

4. The food product according to claim 1, wherein the surface of the product is further coated with a solution comprising a chemical base applied to the surface separately from the coating with the oil free extract from grape seeds.

5. The food product according to claim 1, wherein the chemical base is a baking soda.

6. The food product according to claim 1, wherein the product is a frozen food product.

7. The food product according to claim 6, wherein the product is designed to be heated in a microwave oven.

8. The food product according to claim 1, wherein the surface of the product is partly coated with the oil free extract from grape seeds.

9. The food product according to claim 1, wherein the product is selected from the group consisting of dough, bread, cookies, cereals, bakery products, pizzas, snacks, gratins, cooked pasta, lasagna, cheese dishes and rice dishes.

10. Method for coloring a surface of a food product when heated, comprising the steps of: coating the surface or a part thereof with a composition comprising an oil free extract from grape seeds; and heating the product in order to develop a color of the surface.

11. The method according to claim 10, comprising the step of applying to the surface a solution comprising a chemical base before heating the product.

12. The method according to claim 10, comprising the step of applying to the surface a solution comprising an ion of a transition metal before heating the product.

13. The method according to claim 10, wherein the heating of the product is in a microwave oven.

14. A method comprising applying an oil free extract from grape seeds to a surface of a food product to coat the surface and develop a colored surface of the product when it is heated.

15. The method of claim 14, wherein the oil free extract from grape seeds comprises from 60 to 90 wt % polyphenols.
